(19) United States
(12) Patent Application Publication
(10) Pub. No.: US 2003/0173298 A1
(43) Pub. Date: Sep. 18, 2003

(54) Method for processing a color photographic paper

(75) Inventors: Didier J. Martin, Givry (FR); Tanneguy De Poulpiquet, Baron sur Odon (FR)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/375,869

(22) Filed: Feb. 25, 2003

(30) Foreign Application Priority Data
Mar. 15, 2002 (FR) 0203195

(51) Int. Cl. B01D 61/00

(52) U.S. Cl. 210/651; 430/430; 430/432; 430/431; 162/162; 427/435

(57) ABSTRACT

The present invention relates to a method for processing an exposed color silver halide photographic paper in processing units having a color paper throughput greater than 200 m²/h comprising the circulation of negative color paper in:

a) a color-forming development area comprising at least one bath,

b) a bleaching-fixing area comprising at least one bath,

c) a first washing area comprising at least one washing bath with a water reinforcement rate less than 300 ml/m², and

d) a further washing area comprising at least two baths placed in series whose water reinforcement rates are greater than 2 l/m²,

this method further comprising the collection of the water from the bath(s) of the first washing area, the circulation of this collected water through a nanofiltration unit to provide a permeate, and the recycling of this permeate in one or more baths of the first washing area.

### FIELD OF THE INVENTION

The present invention relates to the processing of an exposed silver halide color photographic paper in large scale processing units.

### BACKGROUND OF THE INVENTION

The processing of color photographic papers with silver gelatino-halides comprise conventionally, after the exposure of the color photographic paper, the following sequence of processing steps:

1) a step of color development whereby in the exposed areas of the silver gelatino-halide layers of the paper, a silver and a dye image are formed,

2) a step of bleaching-fixing where of the silver image is rehalogenated and the silver halides either rehalogenated or remaining in the non-exposed areas are solubilized, and

3) a step of washing where the residual chemicals present in the layers of the paper or those formed in the layers of the paper during the processing, are removed.

After this processing sequence, a drying step is carried out. Examples of processing of color photographic papers with silver gelatino-halides are described in “Chimie et Physique Photographique” by P. Glàfkides, volume 2, page 960, 5^{th} edition, published by C.E.P. Edition, 1987, Paris.

Large scale processing units for color paper have in general throughputs greater than about 200 m²/h. In such units, the washing step is carried out through, several washing tanks placed in sequence, the volume of each of these tanks being in general between 90 l and 450 l . For the largest units, it is common to use a sequence of up to 8 washing tanks placed in series, with tanks whose volume is between 300 l and 450 l. In practice, photographic materials are developed automatically, continuously and as fast as possible. It is common to use several development lines in parallel in order to increase the throughput of the processing units. During the conveyance of the photographic materials from tank to tank, chemical components are carried over from one tank to another either by the photographic material, or by the conveyor belts of the processor. These chemical components accumulate in the processing baths and especially in the washing baths. The carry-over of these chemical components gets more significant as the processing of the photographic materials gets faster. Large processing units can reach color paper running speeds in the order of 550 m²/h. It is suitable to eliminate these chemicals from the washing baths in order to either recycle the washing water, or discharge to the drains water that is free of polluting chemicals. One of the substances to be removed from the washing baths is silver which as a result of the processing is found in a soluble complex form. However, whatever technique is used, the removal of chemicals from the washing water in large units is difficult because of the high dilution of this washing water, which increases the costs for the removal of the chemicals, and the large volume of water to be stored with a view to being treated.

French Patent Application 2,684,024 describes a method in which the waste washing water from photographic processing is passed through two different membrane filters. The first membrane filter separates, with a relatively high flow rate, the dissolved components at a relatively low concentration in order to concentrate the solution. The concentrated solution is then passed through a second filter that separates an increased concentration of components. This combination of two membrane filters, while it is applicable to waste washing water with low concentration in chemical pollutants, requires a large volume of water because all the washing baths as well as the volumes of water collected by spilling from the overflows have to be treated. This results in the use of large storage units of wastewater in order to enable their subsequent filtration and thus an increase of the operating costs of these processing units.

The present invention provides a method of processing an exposed (or re-exposed) silver halide photographic color paper in large scale units having a color paper throughput greater than about 200 m²/h, not having the problems mentioned above when one has to remove from the washing baths the chemicals contained therein in order to recycle these washing baths or discharge them to the drains.

The method of the invention, for processing an exposed silver halide color photographic paper units having a color paper throughput greater than about 200 m²/h, the method comprising in sequence the steps of:

a) color developing the exposed color paper in at least one development bath,

b) bleaching-fixing the color paper developed in step a) in at least one bleaching-fixing bath,

c) washing the color paper in at least one washing bath whose water replenishment rate is less than 300 ml/m², and

d) further washing the color paper in at least a sequence of two baths placed in series whose water replenishment rates are greater than 2 l/m²,

this method further comprising the steps of collecting the water from the bath(s) of the washing step c), circulating this collected water through a nanofiltration unit to provide a permeate, and recycling this permeate in one or more baths of the washing step c).

The method can further comprise a drying step.

### BRIEF DESCRIPTION OF THE DRAWING

FIG. 1 represents a schematic view of a unit for processing color photographic papers according to the method of the invention.

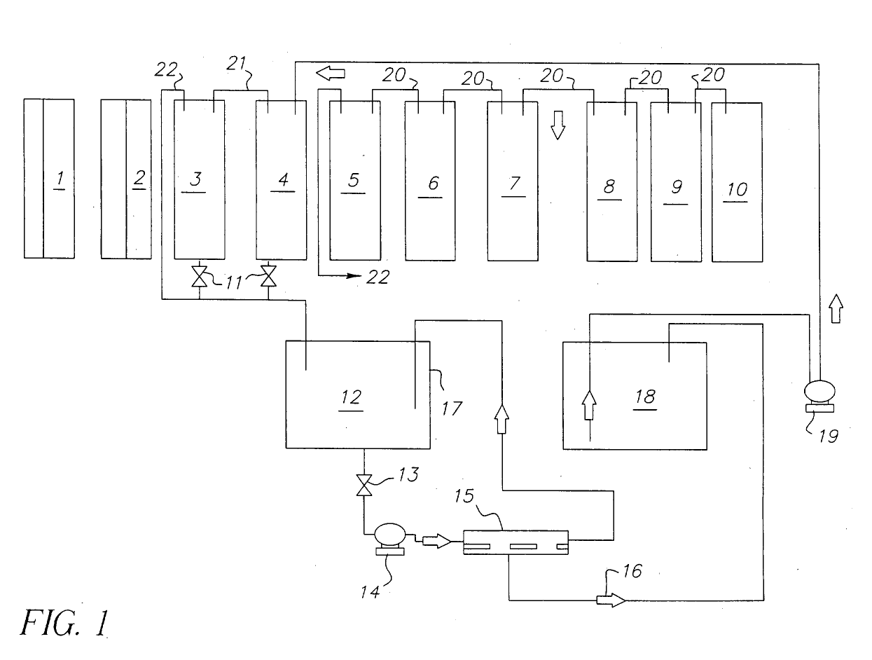

### DETAILED DESCRIPTION OF THE INVENTION

According to an embodiment, the color development step and the bleaching-fixing step comprise each two baths placed in sequence.

The water replenishment rate of the bath(s) of the first washing step that is step c), is preferably between 100 ml/m² and 260 ml/m². This first washing step enables the washing baths to be concentrated in chemicals components coming from the carry-over of significant quantities of solution from one tank to the other either by means of the processed photographic material, or by the conveyor belts of the processor. The presence of a washing area with low water replenishment rate has the effect of concentrating the solutions that are to be circulated through the nanofiltration unit, thus enabling optimum use of this a unit. Thus, it is no longer necessary to carry out two filterings as recommended in French Patent Application 2,684,024.

The collection of the water from the bath(s) of the first washing step, the circulation of this water collected through a nanofiltration unit and the recycling of the permeate in one of the baths of the first washing step have the effect of minimizing the contamination of the baths of the further washing step. The solutions carried over by the color photographic paper or by the conveyor belts of the processor are not charged with pollutants any more.

The water replenishment rate of the baths of the further washing step that is step d), is preferably between 2 l/m² and 11 l/m². This second washing step, with a higher water replenishment rate, provides efficient washing of the photographic material which is a crucial condition to obtain images with good sensitometric characteristics. The optimization of the water consumption in the processing method of the invention, and thus, the number of baths used in the further washing step having a higher water replenishment rate will be adjusted depending on the running speed of the processed photographic color paper. Preferably, from 2, to 6 baths can be used. In a preferred embodiment, these baths are connected through by a counter-current to maintain the water levels in the baths.

Advantageously, the first washing step and/or further washing step with higher water replenishment rate, comprise each at least a sequence of two baths, the baths of each sequence being inter-linked by a counter-current in order to maintain the water level in these baths. This enables the reduction of the overall water consumption in the method of the invention. One of the advantages of the method of the invention is to eliminate the need of more baths in the further washing step with high water replenishment rate without deteriorating the sensitometric quality of the photographic images obtained.

In the method of the invention, the nanofiltration step uses membranes to separate the dissolved substances or chemical products from diluted solutions. Nanofiltration is a technique useful to selectively separate salts and organic compounds in solution. Membranes used for nanofiltration behave like large surface area sieves having pores of microscopic or molecular size whose dimensions must be very even in order that molecules of a defined size are retained while smaller molecules or ions of simple salts go through the membrane. Membranes for nanofiltration generally let through molecules whose molecular weight is in the range of from about 100 to about 1000 Daltons. Multivalent ionized salts and non-ionized organic compounds with molar mass greater than 1000 Daltons are, however, strongly retained.

The solution that has crossed the membrane is called filtrate or permeate and the solution that is retained by the membrane is called concentrate or retentate.

Nanofiltration membranes can be inorganic or organic. Organic membranes are membranes based on cellulose acetate, poly(amide/imide), polysulfone, acrylic polymers or fluoropolymers. Inorganic membranes are membranes based on carbon, ceramics, anodized aluminum, sintered metal or porous glass, or woven composites based on carbon fibers.

Those skilled in the art will adjust routinely the flow rate through the membrane and the pressure applied to the membrane according to the nanofiltration device. In general, the applied pressure is selected in the range of from about 0.5 to about 4 MPa and preferably from 1 to 3 MPa.

Examples of nanofiltration membranes useful according to the invention, are NF45 FILMTEC® membrane, or NF70 FILMTEC® membrane marketed by Dow Europe Separation Systems®; and Osmonics DK® membrane, Osmonics MX® membrane, or Osmonics SV® membrane marketed by Osmonics Company.

The method of the present invention is carried out with a processing installation or equipment having throughputs greater than 200 m²/h.

The processing installation comprises:

a) a color-forming development area comprising at least one development bath,

b) a bleaching-fixing area comprising at least one bleaching-fixing bath,

c) a first washing area comprising at least one washing bath having a water replenishment rate less than 300 ml/m²,

d) a further washing area comprising at least two baths placed in series whose water replenishment rates are greater than 2 l/m²,

e) means to recover the water of the first washing area,

f) a nanofiltration unit through which is circulated the water from the first washing area, and

g) means to recycle the permeate from said nanofiltration unit in one or more baths of the first washing area.

In an embodiment, the installation comprises two color development baths and two bleaching-fixing baths.

Means to collect the water of the first washing area are, for example, drain valves, overflows, a hydraulic pump and/or a storage tank. The permeate from the nanofiltration unit can by recycled in one or more baths of the first washing area, for example, with a hydraulic pump and a tank.

In the description that follows, reference will be made to the single FIGURE of the drawing that schematically represents an embodiment of the above processing installation.

The exposed photographic material (not shown) is brought into a color development area (1) comprising two baths, from the output of which it goes into a bleaching-fixing area (2) comprising two baths, and then it goes into the first washing area composed of baths (3) and (4), which are inter-linked by a counter-current (21). Then, the photographic material goes into a further washing area made up of baths (5), (6), (7), (8), (9) and (10), which are inter-linked by counter-currents (20) in order to maintain the water level of each bath. The washing bath (5) is equipped with an overflow device (22) that enables spent water of the second washing area to be discharged to the drains. The first bath of the first washing area (3) is equipped with an overflow (22) enabling the wastewater overspill to be collected in the tank (12). The washing baths (3) and (4) are equipped with drain valves (11) enabling the bath contents to be collected in a tank (12). From the tank (12), the collected wastewater is taken through a nanofiltration membrane unit (15) by opening the valve (13) and using a high-pressure pump (14). The retentate (17) from the nanofiltration unit (15) can be either evacuated from the circuit, for example to an auxiliary unit (not shown), or recycled in the tank (12). The permeate (16) can supply either an auxiliary source (18) (option shown on the diagram), or one of the baths of the first washing area (option not shown on the diagram). A hydraulic pump (19) enables the bath (4) of the first washing area to be supplied. Parts (not shown) can be added, such as, for example, conductivity measuring devices for the concentrations of the chemical species of the solution in the tank (12), with servo a connection of this tank enabling evacuation of part of the contents when these concentrations reach or exceed a certain limit, to an auxiliary unit (not shown). One example of such an auxiliary unit can be an electrolysis cell to recover the silver. The method according to the invention further enables sending to the auxiliary unit, for example to an electrolysis cell, solutions concentrated in complexed silver, which enables time savings in the recovery of the silver for an equivalent recovery rate.

The invention is described in detail in the following examples.

### EXAMPLE 1

A large scale processing unit was used to process Kodak EKTACOLOR RA-4 (Hostert Fotomata RP83 model, modified for RA-4 processing). This unit uses four processing lines in parallel to process exposed color negative papers of EKTACOLOR® type (such as KODAK EKTACOLOR EDGE 8® and KODAK EKTACOLOR ROYAL VIII® (papers) with the following sequence:

a color development area (1) comprising a sequence of two baths (processing time 22.5 s per bath, temperature 37.8° C.);

a bleaching-fixing area (2) comprising a sequence of two baths (processing time 22.5 s per bath, temperature between 30° C. and 36° C.);

a first washing area with low water replenishment rate (the water replenishment rate is 216 ml/m²) comprising a sequence of two baths, (3) and (4), and inter-linked by a counter-current (baths volume 300 l), the first washing bath is equipped with an overflow;

a further washing area with high water replenishment rate (the water replenishment rate is 4 /m²) comprising a sequence of six baths (baths (5), (6), (7), (8), (9) and (10)) of 300 l inter-linked by a counter-current.

Then, the process is continued conventionally by a drying step (T<96° C.).

For the two tests (comparison and invention), the processing unit was used for a period of seven days with a throughput of processed color negative papers between 440 m²/h and 550 m²/h.

For the comparative test, after seven days operation, the concentrations in silver and iron ions in the various washing baths were measured by the inductively-coupled plasma-atomic emission spectroscopy technique (ICP). The concentrations in sulfite ions were determined by the capillary area electrophoresis technique (CZE). The chemical oxygen demand (COD) was measured according to the standard AFNOR NF T90-101. The results are given in Table 1.

For the test according to the invention, the water volumes from the overflow of the first bath of the first washing area and the daily draining of the two baths of this same washing area were collected. This water was then treated using a nanofiltration membrane NF45 FILMTEC® having a specific treatment surface area of 2.21 m², marketed by Dow Europe Separation Systems®, with a supply flow rate of 600 l/h at a pressure of 2 MPa. The permeate was stored in an auxiliary source, which provides the water replenishment of the baths of the first washing area. Then, the concentrations of chemical pollutants were measured as for the comparative test. The results of the test according to the invention are given in Table 2.

TABLE 1

| Comparative | | | | |
|---|---|---|---|---|
| Washing | Complexed [Ag] | [S₂O₃²⁻] | Complexed [Fe] | COD |
| baths | mg/l | mg/l | mg/l | mg/l |
| (3) | 886 | 14225 | 904 | 24300 |
| (4) | 282 | 3136 | 269 | 5351 |
| (5) | 9 | 86 | 8.9 | 156 |
| (6) | 2 | 20 | 2.4 | 156 |
| (7) | 0.2 | 0 | 0.44 | 88 |
| (8) | 0.02 | 0 | 0.07 | 51 |
| (9) | 0 | 0 | 0.02 | 24 |
| (10) | 0 | 0 | 0.01 | 17 |

TABLE 2

| Invention | Complexed [Ag] | [S₂O₃²⁻] | Complexed [Fe] | COD |
|---|---|---|---|---|
| Washing baths | mg/l | mg/l | mg/l | mg/l |
| (3) | 17 | 252 | 18 | 431 |
| (4) | 0 | 56 | 0 | 100 |
| (5) | 0 | 2 | 0 | 19 |
| (6) | 0 | 0 | 0 | 17 |
| (7) | 0 | 0 | 0 | 17 |
| (8) | 0 | 0 | 0 | 17 |
| (9) | 0 | 0 | 0 | 17 |
| (10) | 0 | 0 | 0 | 17 |

The sensitometric quality obtained with the method of the invention was controlled using control strips, catalogued under the name “Kodak Control Strips, Process RA-4” supplied by Eastman Kodak Company. The control strip measurements were then compared with a reference, representing the optimum operating characteristics for EKTACOLOR RA-4 processing. These control strips were used according to the manual Z-130 “Using Kodak EKTACOLOR RA Chemicals for Process RA-4”, Chapter 7, published by Eastman Kodak Company.

The sensitometric quality of the color negative papers processed by the method of the invention was satisfactory and in compliance with the requirements of the manual referred to above.

The method according to the invention made it unnecessary to use the washing baths of the second washing area with high water replenishment rate (washing baths (5) to (10)). In addition, by using the method according to the invention, it was possible to reduce the number of baths of the second washing area because as from the bath (6) the main chemical contaminants were no longer present in these baths.

What is claimed is:

1. A method for processing an exposed color photographic silver halide paper in a processing unit having a color paper throughput greater than 200 m²/h, said method comprising in sequence the steps of:
a) color developing the exposed color paper in at least one color development bath,
b) bleaching-fixing the color paper developed in step a) in at least one bleaching-fixing bath,
c) washing the color paper in at least one washing bath, whose water replenishment rate is less than 300 ml/m², and
d) further washing the color paper in at least a sequence of two baths whose water replenishment rates are greater than 2 l/m², this method further comprising the steps of collecting the of water from the bath(s) of the washing step c), circulating this collected water through a nanofiltration unit to provide a permeate, and recycling this permeate in one or more baths of the washing step c).

2. The method of claim 1 wherein the water replenishment rate of the bath(s) of the washing step c) is in the range of from 100 ml/m² to 260 ml/m².

3. The method of claim 1 wherein the water replenishment rate of the baths of the washing step d) is in the range of from 2 l/m² to 11 l/M².

4. The method of claim 1 wherein the water washing step c) comprises circulating the color paper in at least a sequence of two baths inter-linked by a counter-current.

5. The method of claim 1 wherein the washing step d) comprises circulating the color paper in at least a sequence of two baths inter-linked by a counter-current.

6. The method of claim 1, wherein the water washing steps c) and d) each comprises circulating the color paper in at least a sequence of two baths interlinked by a counter current.

7. The method of claim 6, wherein the replenishment rate of the bath(s) of the washing step c) is in the range of from 100 to 260 ml/m² and the replenishment rate of the baths of the washing step d) is in the range of from 2 to 11 ml/m².
